(19) United States
(12) Patent Application Publication
(10) Pub. No.: US 2011/0131603 A1
(43) Pub. Date: Jun. 2, 2011

(54) TELEVISION RECEVER, AUTOMATIC CHANNEL SEARCH APPARATUS AND METHOD THEREOF

(75) Inventor: LUNG DAI, Tu-Cheng (TW)

(73) Assignee: HON HAI PRECISION INDUSTRY CO., LTD., Tu-Cheng (TW)

(21) Appl. No.: 12/889,532

(22) Filed: Sep. 24, 2010

(30) Foreign Application Priority Data
Nov. 30, 2009 (CN) 200910310676.X

(51) Int. Cl. H04N 7/173; H04N 5/50; H04N 5/44

(52) U.S. Cl. 725/38; 348/553; 725/110; 348/732; 348/E05.097; 348/E05.099

(57) ABSTRACT

An automatic channel search method for updating a channel list, the channels list records the channel information. The automatic channel search method is performed by following the steps of: searching current available channels to obtained channel information a interval of a predetermined search period; and updating the channel list according to the obtained channel information.

### BACKGROUND

1. Technical Field

The present disclosure relates to a television system, and particularly to a television receiver, an automatic channel search apparatus and method thereof.

2. Description of Related Art

When a television is being set up for the first time, it is often necessarily to program the available television channels, and store them in a channel list. This may be performed by doing a channel search.

However, some television channels previously stored are not currently available channels when users change the position or location of the television, or broadcast stations, which offer the television channels deletes them. Conventional televisions need to be re-programmed for available television channels. This is inconvenient and time consuming.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the two views.

FIG. 1 is a function block diagram of a channel search apparatus in accordance with an exemplary embodiment.

FIG. 2 is a flow chart of an automatic channel search method in accordance with a first exemplary embodiment.

### DETAILED DESCRIPTION

The present disclosure provides a television receiver with an automatic channel search apparatus and method to enable the television receiver to automatically search and re-program the channels and update the channel list stored in the television receiver.

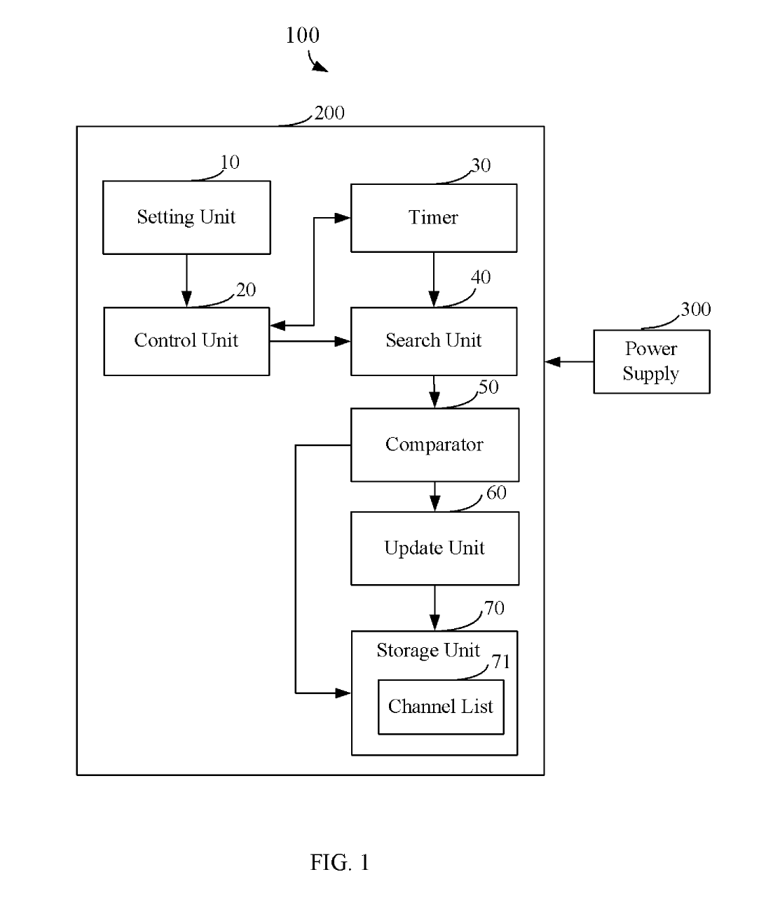

Referring FIG. 1, a television receiver 100 as illustrated includes a channel search apparatus 200 and a power supply 300. The power supply 300 provides the channel search apparatus 200 with electrical power when the television receiver 100 is not turned on. The channel search apparatus 200 includes a setting unit 10, a control unit 20, a timer 30, a channel search unit 40, a comparator 50, an update unit 60, and a storage unit 70.

The storage unit 70 records channel information as a channel list 71. The channel information includes channel names and numbers. The channel list 71 is blank by default, and can receive channel information only after the television receiver 100 does a first channel search.

The setting unit 10 sets a predetermined search period in response to a user's operation. For example, the search period may be set as two weeks by the user operating a remote device (not shown) corresponding to the television receiver 100 or by the manufacturer in advance.

The control unit 20 generates a timing signal. For example, the control unit 20 generates the timing signal when the predetermined search period is to be performed.

The timer 30 counts the time in response to the timing signal, and generates a search signal when the counted time reaches the predetermined search period.

The search unit 40 searches currently available channels one by one to obtained channel information in response to the search signal. The search unit 40 also sends the obtained channel information to the comparator 50.

The comparator 50 determines whether the obtained channel information has been recorded in the channel list 71 by comparing the obtained channel information with the channel information of the channel list 71. For example, if information of one of the obtained channels is the same as information of one of the channels of the channel list 71, it is determined that the information of the one of the obtained channels has been recorded in the channel list 71. Otherwise, if information of one of the obtained channels is different from all of the channel information of the channel list 71, it is determined that the information of the one obtained channel has not been recorded in the channel list 71. The comparator 50 also determines whether the television signals from obtained channels meet the requirements of a predetermined standard television signal by comparing the television signals from obtained channels with the predetermined standard television signal. The requirements of the predetermined standard television signal meet such requirements as color requirements or sound requirements. The comparator 50 generates a first update signal to add the obtained channel information into the television list 71 if the obtained channel information has not been recorded in the channel list 71 and the television signals from the obtained channel meet the requirements of the predetermined standard television signal. The comparator 50 further generates a second update signal to delete the channel information corresponding to the obtained channel from the channel list 71 if the corresponding obtained channel has been recorded in the channel list 71 and the television signals from the corresponding obtained channel does not meet the requirements of the predetermined standard television signal.

The update unit 60 adds the obtained channel information or deletes the channel information from the channel list 71 to update the channel list 71 in response to the first and the second updated signals.

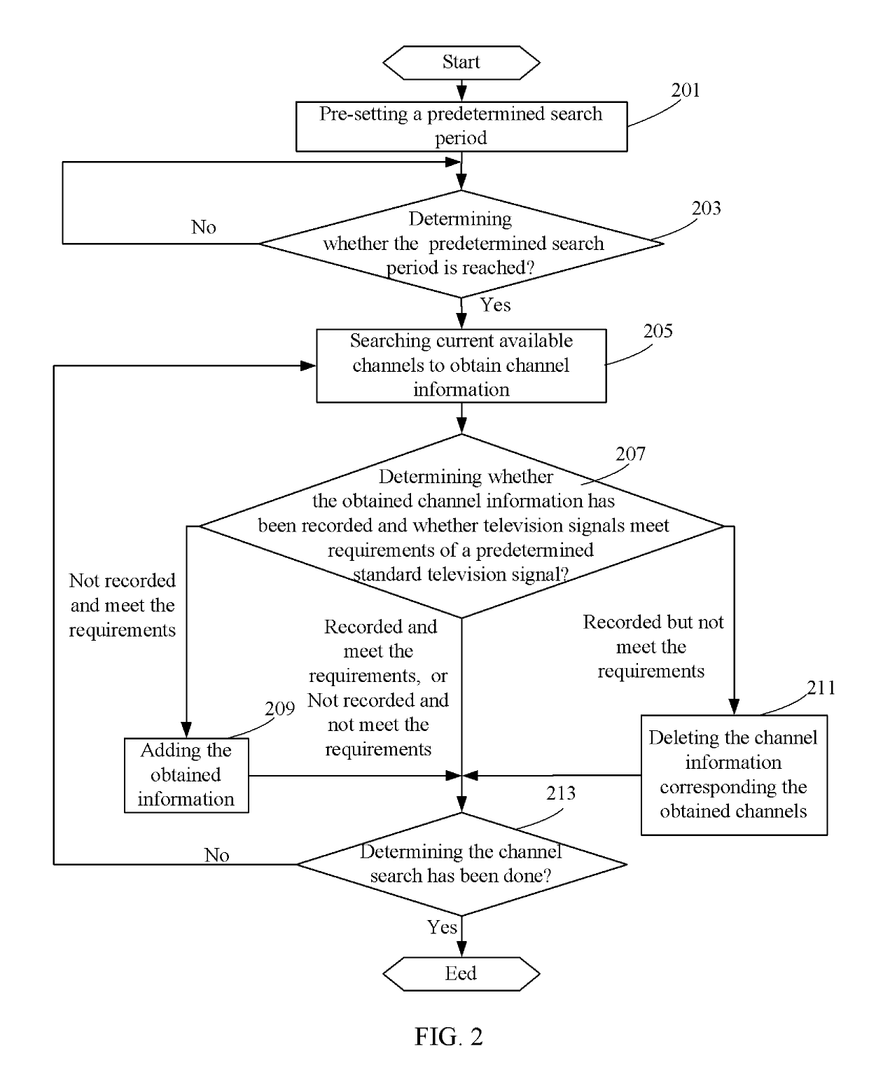

Referring to FIG. 2, an automatic channel search method by a television receiver in accordance with a first embodiment is illustrated. The television receiver includes a channel list to record channel information. The automatic channel search method includes the following steps.

In step 201, pre-setting a predetermined search period. For example, the predetermined search period can be set as two weeks by a user or by a manufacturer.

In step 203, determining whether the predetermined search period is reached. For example, the television begins to count the time when the predetermined search period is to be performed, and determine the predetermined search period is reached when the counted time is equal to the predetermined search period.

In step 205, searching current available channels to obtain current available channel information if the predetermined search period is reached. The channel information includes the channel name and the channel number.

In step 207, determining whether the obtained channel information has been recorded in the channel list and whether television signals from the obtained channels meet the requirements of a predetermined standard television signal. For example, comparing the obtained channel information such as the name of the channel with the information of the channel list to determine if the obtained channel information has been recorded in the channel list and whether television signals from the obtained channels meet the requirements of a predetermined standard television signals. If a name of one of the obtained channels is the same as the information of the channel list, it is determined that the information of one of the obtained channels has been recorded in the channel list. Otherwise, if a name of one of obtained channels is different from all of the channels information of the channel list, it is determined the information of the obtained channel has not been recorded in the channel list. Then, comparing the television signals from the obtained channels with the predetermined standard channel signal to determine whether the television signals from the obtained channels meets the requirements of the predetermined standard television signals. The requirements of the predetermined standard television signal such as the color requirements or sound requirements.

In step 209, recording the obtained channel information if the obtained channel information has not been recorded in the channel list and the television signals from obtained channels meet the requirements of the predetermined standard television signal.

In step 211, delete the channel information corresponding to the obtained channels from the channel list if the corresponding channel information has been recorded in the channel list and the television signals from the corresponding channels obtained do not meet the requirements of the predetermined standard channel signal.

In step 213, determining whether the channel search has been done. If the channel search has not been done, repeating the steps 205 to 213.

As described above, the television receiver 100 and the automatic channel search method not only can do a channel search automatically and periodically, but also can prevent the one channel's information from being repeatedly recoded in the channel list 71 by comparing the current available channel information with the channel's information of the channel list 71. Furthermore, the television receiver 100 and the automatic channel search method can also stop recording the channel information corresponding to the channels, which have bad television signals, thus it can obviate any inconvenience in the user television viewing.

It is to be understood, however, that even though information and advantages of the present embodiments have been set forth in the foregoing description, together with details of functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An automatic channel search apparatus comprising:
a storage unit to store channel information as a channel list;
a timer unit to generate a search signal at a interval of a predetermined search period;
a search unit to search current available channels to obtain current channel information in response to the search signal; and
an update unit to update the channel list according to the obtained channel information.

2. The automatic channel search apparatus of claim 1, further comprising a control unit to generate a timing signal to control the timer to begin to count time in response to a user's operation.

3. The automatic channel search apparatus of claim 2, further comprising a setting unit to set the predetermined period in response to the user's operation, the controller generating the timing signal when the predetermined period is to be performed.

4. The automatic channel search apparatus of claim 1, further comprising a comparator to determine whether the obtained channel information has been recorded in the channel list by comparing the obtained channel information with the channel information of the channel list, the update unit adding the obtained channel information which has not been recorded in the channel list.

5. The automatic channel search apparatus of claim 4, wherein the comparator is further configured to determine whether television signals from the obtained channels meet requirements of a predetermined television signal by comparing the television signals from the obtained channels with the predetermined standard television signal, the update unit adding the obtained channel information if the obtained channel information has not been recorded in the channel list and the television signals from the obtained channels meet the requirements of the predetermined standard television signal.

6. The automatic channel search apparatus of claim 5, wherein the update unit is further configured to delete the channel information from the channel list if the channel information is corresponding to the obtained channels and the television signal from the television signals do not meet the requirements of the predetermined standard television signal.

7. An automatic channel search method for updating a channel list, the channels list configured to recorded channel information, the automatic channel search method comprising steps of:
searching current available channels to obtain current channel information at a interval of a predetermined search period; and
updating the channel list according to the obtained channel information.

8. The automatic channel search method of claim 7, further comprising:
determining whether the obtained channel information has been recorded in the channel list; and
adding the obtained channel information if the obtained channel information has not been recorded in the channel list.

9. The automatic channel search method of claim 8, further comprising:
determining whether television signals from the obtained channels meet a predetermined standard television signal; and
adding the obtained channel information if the obtained channel information has not been recorded in the channel list and the television from the obtained channels meet the predetermined standard television signal.

10. The automatic channel search method of claim 9, further comprising:
deleting the channel information if the channel information is corresponding to the obtained channels and the television signals from the corresponding the obtained channels do not meet the predetermined standard television signal.

11. A television receiver comprising:
an automatic channel search apparatus, and a power supply for supplying power to the automatic channel search apparatus during the television receiver is turned off, wherein the automatic channel search apparatus comprising:
a storage unit to store channel information as a channel list;
a timer unit to generate a search signal a interval of a predetermined search period;
a search unit to search current available channels to obtain channel information in response the search signal; and
an update unit to update the channel list according to the obtained channel information.

12. The television receiver of claim 11, wherein the automatic channel search apparatus further comprises a control unit to generate a timing signal to control the timer to begin to count time in response to a user's operation.

13. The television receiver of claim 12, wherein the automatic channel search apparatus further comprises a setting unit to set the predetermined period in response to the user's operation, the controller generates the timing signal when the predetermined search period is to be performed.

14. The television receiver of claim 11, wherein the automatic channel search apparatus further comprises a comparator to determine whether the obtained channel information has been recorded in the channel list by comparing the obtained channel information with the channel information of the channel list, the update unit adds the obtained channel information which has not been recorded in the channel list.

15. The television receiver of claim 14, wherein the comparator is further configured to determine whether television signals from the obtained channels meet requirements of a predetermined television signal by comparing the television signals from the obtained channels with the predetermined standard television signal, the update unit adding the obtained channel information if the obtained channel information has not been recorded in the channel list and the television signals from the obtained channels meet the requirements of the predetermined standard television signal.

16. The television receiver of claim 15, wherein the update unit is further configured to delete the channel information from the channel list if the channel information is corresponding to the obtained channels and the television signal from the television signals do not meet the requirements of the predetermined standard television signal.
